(19) United States
(12) Patent Application Publication
(10) Pub. No.: US 2022/0244021 A1
(43) Pub. Date: Aug. 4, 2022

(54) LIGHTWEIGHT ARMOR

(71) Applicant: Foster-Miller, Inc., Waltham, MA (US)

(72) Inventors: Joseph V. Malone, Franklin, MA (US); Thomas H. Mann, Littleton, MA (US); John D. Larouco, Milford, MA (US); Christian Joseph MacLeod, Framingham, MA (US)

(21) Appl. No.: 17/591,209

(22) Filed: Feb. 2, 2022

Related U.S. Application Data
(60) Provisional application No. 63/145,748, filed on Feb. 4, 2021.

(51) Int. Cl. F41H 5/013; F41H 5/04; B64C 1/06

(52) U.S. Cl. CPC F41H 5/013; B64C 1/066; F41H 5/0478

(57) ABSTRACT

Lightweight armor includes an inner liner with releasable fasteners on its outside surface for attachment to an aircraft interior releasable fastener layer and with an inside surface including releasable fasteners. A plurality of tiles of pressed polymer fibers in a resin matrix are secured to the inner liner inside surface with releasable fasteners. A cover is secured to the tiles with releasable fasteners.

### RELATED APPLICATIONS

This application claims benefit of and priority to U.S. Provisional Application Ser. No. 63/145,748 filed Feb. 4, 2021, under 35 U.S.C. §§ 119, 120, 363, 365, and 37 C.F.R. § 1.55 and § 1.78, which is incorporated herein by this reference.

### FIELD OF THE INVENTION

This subject invention relates to a new lightweight armor for the interior of vehicles such as aircraft.

### BACKGROUND OF THE INVENTION

Armor for the interior of vehicles such as aircraft is known. See U.S. Pat. Nos. 8,596,182; 5,170,690; and 5,333,532. Ballistic protective material (e.g., Kevlar®) and/or a hard face layer (e.g., ceramic) are typically used.

For aircraft applications especially, armor weight and effectiveness are tradeoffs and most hard face layers add a lot of weight to the aircraft lowering its useful load. Modularity, easy of installation, and repairability are also concerns.

### BRIEF SUMMARY OF THE INVENTION

In one preferred embodiment, the new vehicle interior armor is lighter in weight and yet still provides protection of the crew, passengers, and aircraft systems from small arms fire. The new armor can also be modular for optional use, is easy to install and remove, and can be repaired.

Featured is lightweight armor comprising an inner liner with releasable fasteners on its outside surface for attachment to an aircraft interior releasable fastener layer and with an inside surface including releasable fasteners, a plurality of tiles of pressed polymer fibers in a resin matrix and secured to the inner liner inside surface with releasable fasteners, and a cover secured to the tiles with releasable fasteners.

In one example, each tile includes a sealant, and the cover is made of vinyl. Each tile may include a rear face with releasable fasteners for releasably securing to the inner liner inside surface releasable fasteners. Each tile may include a front face with releasable fasteners and the cover includes an inside surface with releasable fasteners for mating with the front face releasable fasteners of the tiles. The cover may include one or more folding edge tabs and each folding edge tab includes an outside surface with releasable fasteners for securing to the aircraft interior releasable fastener layer. Each folding edge tab preferably includes an inside surface with releasable fasteners for securing to the inner liner outside surface releasable fasteners.

Also featured is lightweight armor comprising an inner liner with releasable fasteners on its outside surface and with an inside surface including releasable fasteners, and a plurality of tiles of pressed polymer fibers in a resin matrix. Each tile preferably includes a rear face with releasable fasteners for securing to the inner liner inside surface releasable fasteners and a front face with releasable fasteners. A cover includes inside surface with releasable fasteners for mating with the front face releasable fasteners of the tiles.

In one aspect, the lightweight armor includes an inner liner with releasable fasteners on its outside surface and with an inside surface including releasable fasteners, a plurality of tiles of pressed polymer fibers in a resin matrix and secured to the inner liner inside surface with releasable fasteners, and a cover secured to the tiles with releasable fasteners, said cover including one or more folding edge tabs each including an outside surface with releasable fasteners and an inside surface with releasable fasteners for securing to the inner liner outside surface.

Also featured is a lightweight armor panel comprising an inner liner with releasable fasteners on its outside surface and with an inside surface including releasable fasteners, and a plurality of tiles of pressed polymer fibers in a resin matrix. Each tile includes a rear face with releasable fasteners releasably secured to the inner liner inside surface releasable fasteners. A cover includes an inside surface with releasable fasteners. Each tile includes a front face with releasable fasteners releasably secured to the cover inside surface releasable fasteners. The cover includes one or more folding edge tabs wherein each folding edge tab including an outside surface with releasable fasteners including an inside surface with releasable fasteners secured to the inner liner outside surface releasable fasteners.

Also featured is a method of securing armor to the interior of an aircraft. A releasable fastener material is attached to a portion of the aircraft interior. An inner liner with releasable fasteners on its inside and outside surfaces is secured to the aircraft releasable fastener material. A plurality of tiles of pressed polymer fibers in a resin matrix and with inside and outside surfaces including releasable fasteners is attached to the inner liner inside surface. A cover with an inside surface having releasable fasteners is secured to the tiles. The preferred cover includes one or more folding edge tabs each including inside and outside surfaces with releasable fasteners and the method further including folding the edge tabs to mate with the inside surface with the inner liner and to mate with the outside surface with the aircraft interior fastener material.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic view showing a plurality of tiles to be releasably secured to an inner liner;

FIG. 2 is a schematic exploded view showing the primary components associated with the new lightweight armor;

FIG. 3 is a side view of the armor of FIG. 2;

FIG. 4 is a schematic rear view of the armor; and

FIG. 5 is a schematic view showing three armor panels installed in the inside of an aircraft.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

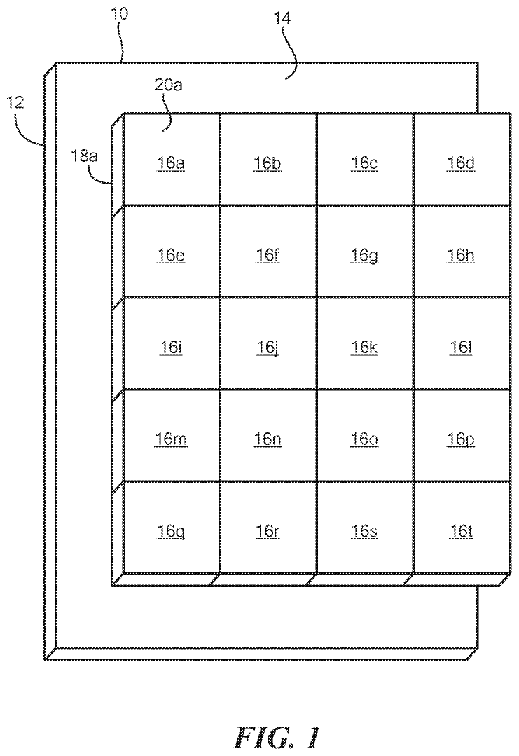

In one aspect, the new interior armor preferably does not include Kevlar® or ceramic. Instead, there is an inner liner 10, FIG. 1, with releasable fasteners (e.g., Velcro® loops) on its outside surface 12 for releasably fastening to an aircraft panel fitted with releasable fasteners (e.g., Velcro® hooks). Inner liner 10 inside surface 14 also includes releasable fasteners (e.g., Velcro® loops). Inner liner 10 may be ⅛″ thick and in one example includes two woven loop fabrics laminated together. Tiles 16a-16t are configured as a combined strike face to stop small arms fire and as a spall liner to capture spall. In one embodiment, each tile is a composite fabrication of pressed ultra-high molecular weight polyethylene unidirectional fibers encapsulated in a resin matrix such as the Honeywell “Spectra shield” product. Usually, layers of unidirectional fibers in a prepreg (polyethylene or polyurethane resin) are stacked on top of each other, heated, and pressed resulting in tiles, for example, 8″ by 8″ in area and ½″ to ⅝″ thick. Other sizes, shapes and thicknesses are possible. Such tiles save weight over prior designs using ceramic yet offer adequate protection. Both faces of each tile are preferably painted with a sealant such as an epoxy paint which seals the tile surfaces.

Tiles 16a-16t each have a rear face 18 with a releasable fasteners (e.g., Velcro® hooks) adhered to each tile. Each tile also has a front face 20 with releasable fasteners (e.g., Velcro® hooks) adhered to each tile.

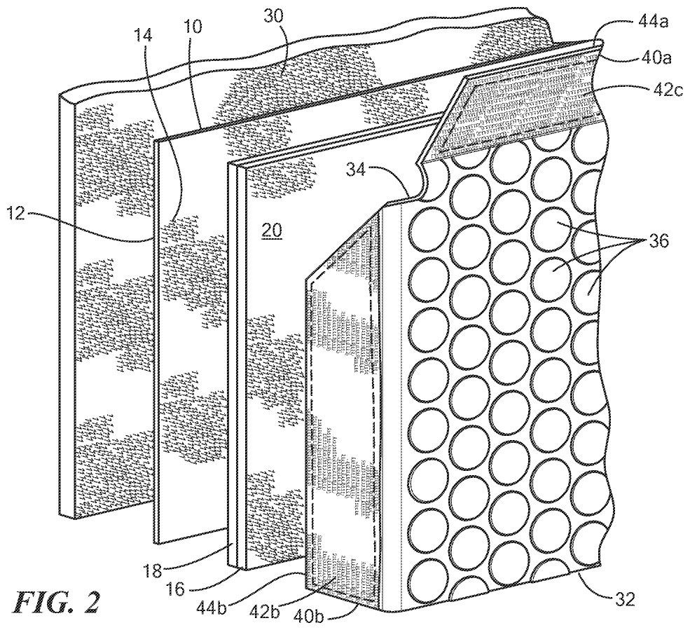

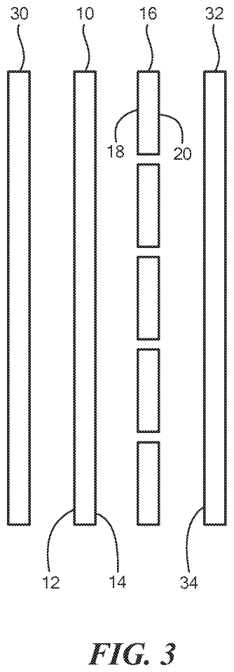

In this way, after an aircraft panel or area is fitted with a releasable fastener layer (e.g., Velcro® hooks 30, FIGS. 2-3) using an adhesive, inner liner 10 is releasably secured thereto as the outside surface 12 Velcro® loops mate with the hooks 30 of the aircraft interior panels. Then, the backside 18 of tiles 16, fitted with Velcro® hooks, are pressed onto the inside surface loops 14 of inner liner 10. The tiles may be arranged in an array.

Next, vinyl cover 32, FIGS. 2-3, (e.g., 0.092-0.103 inches thick) is secured to the tiles. Vinyl cover 32 preferably includes inside surface 34 with releasable fasteners (e.g., Velcro® loops) which mate with the Velcro® hooks on each tile front face 20. Vinyl cover 32 adds durability to the armor, may be flame retardant, and also captures spall. Molded circles 36 on the outside surface of cover 32 serve to add traction to the surface of the vinyl.

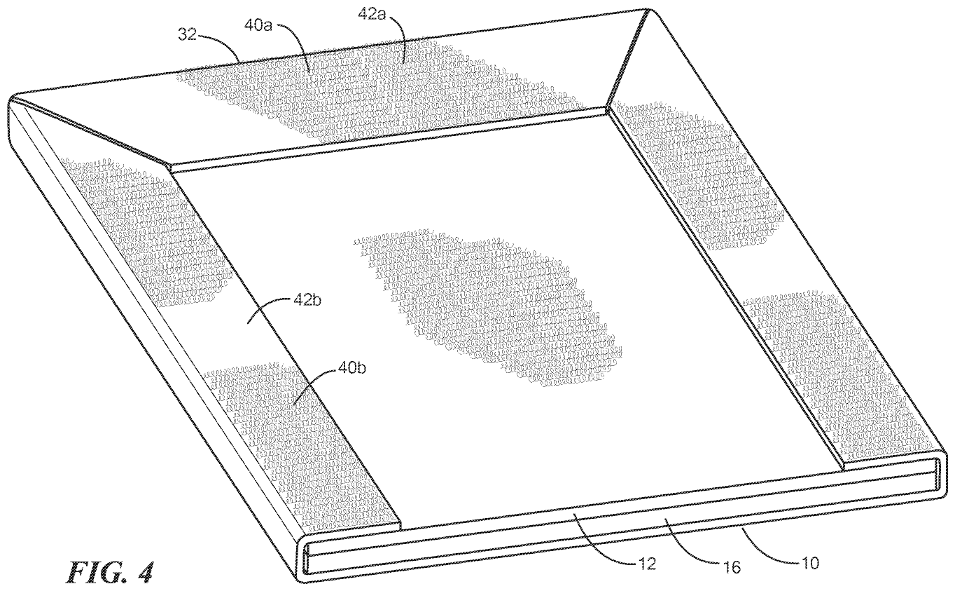

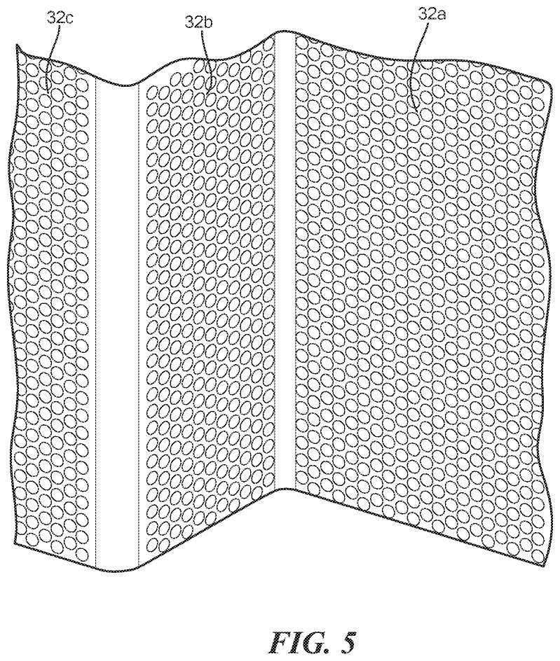

Cover 32 may also include edge tabs 40a, 40b, FIG. 2, (typically one edge tab per side) with releasable fasteners (e.g., Velcro® loops) 42 on the outside and releasable fasteners 44 (e.g., Velcro® hooks) on the inside. Thus, cover 32 edge tabs 40a, 40b, and the like, are folded over the tiles 16 and the inner liner 12 as shown in FIG. 4. Especially when the tiles are smaller, the cover 32 securely retains the tiles in place in an array. The inside tab Velcro® hooks releasably mate with loops 12 on the outside surface 12 of liner 10. The outside Velcro® loops 42 on the edge tabs releasably mate with the Velcro® hooks 30 applied to the interior of the of the aircraft. FIG. 5 shows the covers 32a, 32b, and 32c of three armor panels secured to an aircraft's interior.

The Velcro® material may be reversed in some designs from that disclosed above and Velcro® material layers may be adhered to their respective surfaces using an epoxy. There are other ways to render a given surface fitted with releasable fasteners.

Accordingly, in one preferred embodiment, the new vehicle interior armor is lighter in weight and yet still provides protection of the crew, passengers, and aircraft systems. The new armor is also modular and can be secured within the aircraft and also removed when needed to provide for easier and faster installation and removal.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

What is claimed is:

1. Lightweight armor comprising:
an inner liner with releasable fasteners on its outside surface for attachment to an aircraft interior releasable fastener layer and with an inside surface including releasable fasteners;
a plurality of tiles of pressed polymer fibers in a resin matrix and secured to the inner liner inside surface with releasable fasteners; and
a cover secured to the tiles with releasable fasteners.

2. The armor of claim 1 in which each tile includes a sealant.

3. The armor of claim 1 in which the cover is made of vinyl.

4. The armor of claim 1 in which each tile includes a rear face with releasable fasteners for releasably securing to the inner liner inside surface releasable fasteners.

5. The armor of claim 1 in which each tile includes a front face with releasable fasteners and the cover includes an inside surface with releasable fasteners for mating with the front face releasable fasteners of the tiles.

6. The armor of claim 1 in which the cover includes one or more folding edge tabs.

7. The armor of claim 6 in which each folding edge tab includes an outside surface with releasable fasteners for securing to the aircraft interior releasable fastener layer.

8. The armor of claim 6 in which each folding edge tab includes an inside surface with releasable fasteners for securing to the inner liner outside surface releasable fasteners.

9. Lightweight armor comprising:
an inner liner with releasable fasteners on its outside surface and with an inside surface including releasable fasteners;
a plurality of tiles of pressed polymer fibers in a resin matrix;
each tile including a rear face with releasable fasteners for securing to the inner liner inside surface releasable fasteners;
each tile including a front face with releasable fasteners; and
a cover including inside surface with releasable fasteners for mating with the front face releasable fasteners of the tiles.

10. The armor of claim 9 in which each tile includes a sealant.

11. The armor of claim 9 in which the cover is made of vinyl.

12. The armor of claim 9 in which the cover includes one or more folding edge tabs.

13. The armor of claim 12 in which each folding edge tab includes an outside surface with releasable fasteners.

14. The armor of claim 12 in which each folding edge tab includes an inside surface with releasable fasteners for securing to the inner liner outside surface releasable fasteners.

15. Lightweight armor comprising:
an inner liner with releasable fasteners on its outside surface and with an inside surface including releasable fasteners;
a plurality of tiles of pressed polymer fibers in a resin matrix and secured to the inner liner inside surface with releasable fasteners; and
a cover secured to the tiles with releasable fasteners, said cover including one or more folding edge tabs each including an outside surface with releasable fasteners and an inside surface with releasable fasteners for securing to the inner liner outside surface.

16. The armor of claim 15 in which each tile includes a sealant.

17. The armor of claim 15 in which the cover is made of vinyl.

18. The armor of claim 15 in which each tile includes a rear face with releasable fasteners for releasably securing to the inner liner inside surface releasable fasteners.

19. The armor of claim 15 in which each tile includes a front face with releasable fasteners and the cover includes an inside surface with releasable fasteners for releasably mating with the front face releasable fasteners of the tiles.

20. A lightweight armor panel comprising:
an inner liner with releasable fasteners on its outside surface and with an inside surface including releasable fasteners;
a plurality of tiles of pressed polymer fibers in a resin matrix;
each tile including a rear face with releasable fasteners releasably secured to the inner liner inside surface releasable fasteners;
a cover including an inside surface with releasable fasteners;
each tile including a front face with releasable fasteners releasably secured to the cover inside surface releasable fasteners;
the cover including one or more folding edge tabs;
each folding edge tab including an outside surface with releasable fasteners; and
each folding edge tab including an inside surface with releasable fasteners secured to the inner liner outside surface releasable fasteners.

21. A method of securing armor to the interior of an aircraft, the method comprising:
attaching a releasable fastener material to a portion of the aircraft interior;
securing an inner liner with releasable fasteners on its inside and outside surfaces to the aircraft releasable fastener material;
attaching a plurality of tiles of pressed polymer fibers in a resin matrix and with inside and outside surfaces including releasable fasteners to the inner liner inside surface; and
securing a cover with an inside surface having releasable fasteners to the tiles.

22. The method of claim 21 in which the cover includes one or more folding edge tabs each including inside and outside surfaces with releasable fasteners and the method further including folding the edge tabs to mate with the inside surface with the inner liner and to mate with the outside surface with the aircraft interior fastener material.
